(19) United States
(12) Patent Application Publication
(10) Pub. No.: US 2015/0298284 A1
(43) Pub. Date: Oct. 22, 2015

(54) Polishing System with Front Side Pressure Control

(71) Applicant: Applied Materials, Inc., Santa Clara, CA (US)

(72) Inventor: Jeffrey Drue David, San Jose, CA (US)

(21) Appl. No.: 14/257,619

(22) Filed: Apr. 21, 2014

(51) Int. Cl. B24B 37/04; H01F 1/44; B24B 29/00

(52) U.S. Cl. CPC B24B 37/046; B24B 29/00; H01F 1/447

(57) ABSTRACT

A polishing apparatus includes a platen having a first surface to support a polishing pad and a second surface opposite to the first surface, a carrier head to hold a substrate against the polishing pad, and a control assembly adjacent the second surface of the platen and opposite to the carrier head. The platen comprises a platen material having an adjustable rigidity. The control assembly is configured to control the rigidity of the platen material.

### TECHNICAL FIELD

This disclosure relates to the architecture of a chemical mechanical polishing (CMP) system.

### BACKGROUND

An integrated circuit is typically formed on a substrate by the sequential deposition of conductive, semiconductive, or insulative layers on a silicon wafer. One fabrication step involves depositing a filler layer over a non-planar surface and planarizing the filler layer. For certain applications, the filler layer is planarized until the top surface of a patterned layer is exposed. A conductive filler layer, for example, can be deposited on a patterned insulative layer to fill the trenches or holes in the insulative layer. After planarization, the portions of the conductive filler layer remaining between the raised pattern of the insulative layer form vias, plugs, and lines that provide conductive paths between thin film circuits on the substrate. For other applications, such as oxide polishing, the filler layer is planarized until a predetermined thickness is left over the non planar surface. In addition, planarization of the substrate surface is usually required for photolithography.

Chemical mechanical polishing (CMP) is one accepted method of planarization. This planarization method typically requires that the substrate be mounted on a carrier or polishing head. The exposed surface of the substrate is typically placed against a rotating polishing pad. The carrier head provides a controllable load on the substrate to push it against the polishing pad. An abrasive polishing slurry is typically supplied to the surface of the polishing pad.

Some carrier heads include multiple independently pressurizable chambers so that pressure on different regions of the back surface of the substrate, i.e., the surface that is not being polished, can be controlled.

### SUMMARY

In one aspect, a polishing apparatus includes a platen having a first surface to support a polishing pad and a second surface opposite to the first surface, a carrier head to hold a substrate against the polishing pad, and a control assembly adjacent the second surface of the platen and opposite to the carrier head. The platen comprises a platen material having an adjustable rigidity. The control assembly is configured to control the rigidity of the platen material.

In another aspect, a method comprises holding a substrate against a polishing pad supported by a first surface of a platen, and polishing a surface of the substrate by applying an interface pressure between the substrate and the polishing pad. The platen comprises a platen material having an adjustable rigidity. The interface pressure is adjusted by adjusting the rigidity of the platen material.

Implementations of the apparatuses and/or the methods may include one or more of the following features. The rigidity of the platen material is responsive to an applied magnetic field and the control assembly generates a controllable magnetic field to be applied to the platen material. The platen comprises a bladder having a wall and containing a fluid material inside the wall, the fluid material comprises particles dispersed in a carrier fluid, and the dispersion and/or orientation of the particles is responsive to the controllable magnetic field. The control assembly comprises an array of electromagnets configured to produce the controllable magnetic field. A controller is configured to control each of the electromagnets individually. The controllable magnetic field is produced such that the particles align in chains to change the viscosity of the fluid material in the bladder. A controller is configured to change a magnitude of the controllable magnetic field produced by the electromagnets to change an interface pressure between the polishing pad and the substrate. The bladder comprises segmented compartments, each compartment containing the fluid material. The control assembly comprises a magnet mounted to a linear rail and an actuator to move the magnet along the rail to change magnetic force applied to the platen material. The magnets comprise permanent magnets. The platen material comprises particles dispersed in a carrier fluid, and adjusting the rigidity of the platen material comprises applying a magnetic field to the particles to align the particles and change the viscosity of the platen material. Applying a magnetic field comprises providing an electrical current to an electromagnet located in the vicinity of the platen. The electrical current is applied to an array of electromagnets located in the vicinity of the platen. Each of the electromagnets is controlled independently. Electrical current is applied to selected electromagnets of the array to adjust the rigidity of a selected portion of the platen. The interface pressure is adjusted continuously during the polishing. The interface pressure is applied directly on a first surface of the substrate being polished without first passing through a second surface of the substrate opposite to the first surface.

Implementations can include one or more of the following potential advantages. Pressure on the substrate can be controlled from the outer surface of the substrate. The control pressure can be transferred efficiently to change the interface pressure of the polishing pad in the area of retaining ring and substrate edge.

The details of one or more implementations are set forth in the accompanying drawings and the description below. Other aspects, features and advantages will be apparent from the description and drawings, and from the claims.

### DESCRIPTION OF DRAWINGS

FIG. 1 shows a cross-sectional side view of selected elements of a CMP apparatus.

FIG. 2A schematically illustrates pressure distribution in a stiff substrate.

FIG. 2B schematically shows pressure distribution in a soft substrate.

FIG. 3 schematically shows a profile of interface pressure between a polishing pad and a substrate to be polished.

FIGS. 4A-4C schematically show cross-sectional views of a part of a CMP apparatus.

FIGS. 5A-5B schematically show cross-sectional views of a part of a platen.

### DETAILED DESCRIPTION

Generally, a surface of a substrate to be polished directly contacts a surface of a polishing pad. During polishing, the substrate and the polishing pad move relative to each other, and an interface pressure is applied between the two surfaces. The interface pressure can be a pressure applied from the surface of the substrate towards the surface of the polishing pad, or from the surface of the polishing pad towards the surface of the substrate. The polishing pad of this specification has a rigidity responsive to an applied magnetic field. The interface pressure for polishing the substrate can be adjusted, e.g., at different locations of the polishing pad, by adjusting the rigidity of the pad. A polishing system implementing the polishing pad also includes a control assembly that generates a controllable magnetic field to apply to the pad. In an example, the polishing pad includes a bladder that contains particles dispersed in a carrier fluid. The dispersion and/or orientation of the particles change in response to changes of the strength of the magnetic field applied to the pad, which leads to the change of the pad viscosity.

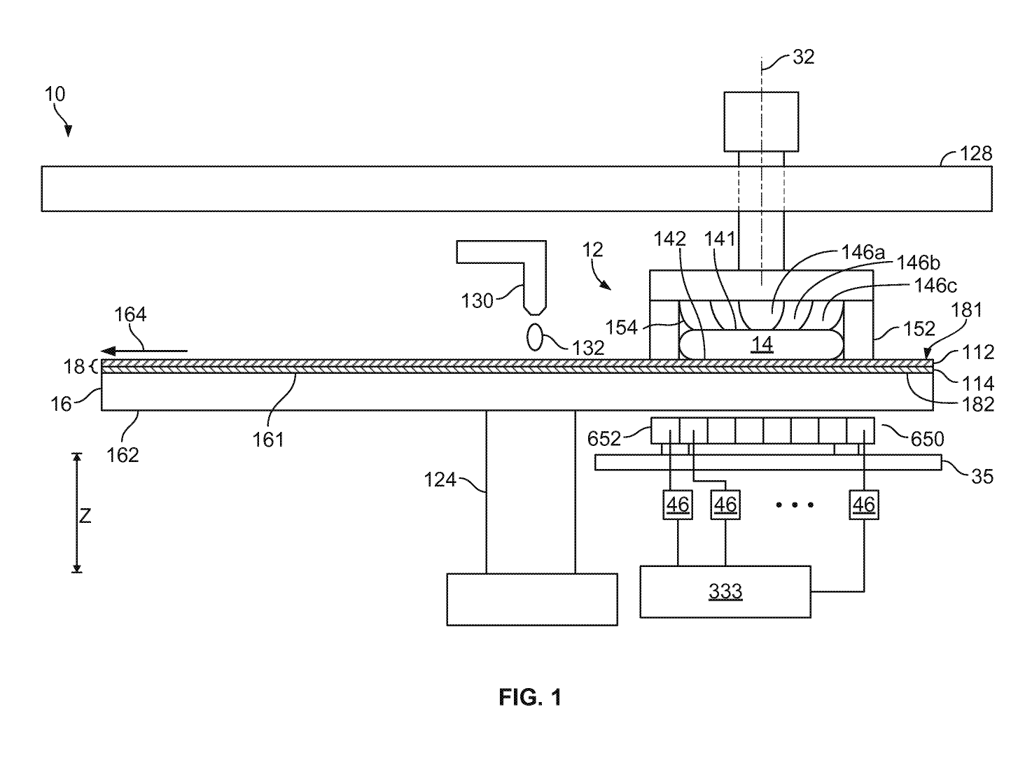

FIG. 1 shows a cross-sectional side view of selected elements of the CMP apparatus 10. The polishing apparatus 10 includes a platen 16 to support a polishing pad 18, and a carrier head 12 to hold a substrate 14 against a polishing surface 181 of the polishing pad 18.

The carrier head 12 can include a retaining ring 152 to retain the substrate 14 below a support structure 154, such as a flexible membrane. During polishing, the support structure 154 abuts an inner face 141 of the substrate. The carrier head 12 can control the polishing parameters, for example pressure, used to polish the substrate 10. For example, the carrier head 12 can include a plurality of independently controllable pressurizable concentric chambers defined by the membrane, e.g., three concentric chambers 146a-146c, which can apply independently controllable pressure to associated zones on the flexible membrane 154 and thus on the substrate 14. Although only three chambers are illustrated in FIG. 1 for ease of illustration, there could be one or two chambers, or four or more chambers, e.g., five chambers. In addition, although only one carrier head is illustrated, there can be more than one carrier head.

The platen 16 has a top surface 161 and a bottom surface 162. The top surface 161 supports the polishing pad 18. A bottom surface 182 of the polishing pad 18 is in contact with the top surface 161 of the platen. The polishing pad 18 can be a two-layer polishing pad with a polishing layer 112 and a backing layer 114. The polishing pad 18 can be secured by an adhesive layer 28 to the platen. The adhesive layer 28 can be a double-sided adhesive tape, e.g., a thin layer of polyethylene terephthalate (PET), e.g., Mylar™, with adhesive, e.g., pressure-sensitive adhesive, on both sides.

In operation, a polishing slurry 132 is fed onto the polishing surface 181 of the polishing pad from a source 130. The carrier head 12 holds the substrate 14 to be polished against the polishing surface 181 of the polishing pad 18 so that an outer surface 142 of the substrate 14 is in contact with the polishing surface 181. An inner face 141 of the substrate 14 opposite to the outer surface 142 is in contact with the membrane 154.

In some implementations, during polishing, the carrier head 12 translates along a lateral dimension 164, e.g., along the radius of the platen 16. For example, the carrier head 12 can move along a track 128 or be carried by a carousel, while the platen 16 rotates. The lateral translation of carrier head 12 allows the substrate 14 to more evenly and fully utilize available surface for polishing on the pad 18.

The pressure with which a portion of the substrate 14 is pressed against the polishing surface 181 of the polishing pad 18 determines the polishing rate experienced by that portion of the substrate. This pressure is also an interface pressure between the surface 142 and the polishing surface 181.

The profile of the substrate after polishing can be referred to as the “post removal profile”. By applying different pressures to different portions of the substrate, the a substrate can be polished to achieve a desired post removal profile. For example when polishing an incoming substrate having uneven surface features (e.g., different surface heights across the substrate), the interface pressure profile across the substrate can be controlled to remove different amounts of material across the surface of the substrate so that the post removal profile of the substrate results in a flat surface. Due to the rotation of the carrier head about the axis 32, the profile of the polished substrates will tend to be substantially rotationally symmetric.

Generally, the pressure received by the lower outer surface 142 can be controlled by controlling the force applied on the inner surface 141 by the carrier head, or controlling the pressure applied directly on the outer surface 142 by the polishing pad 18, or both.

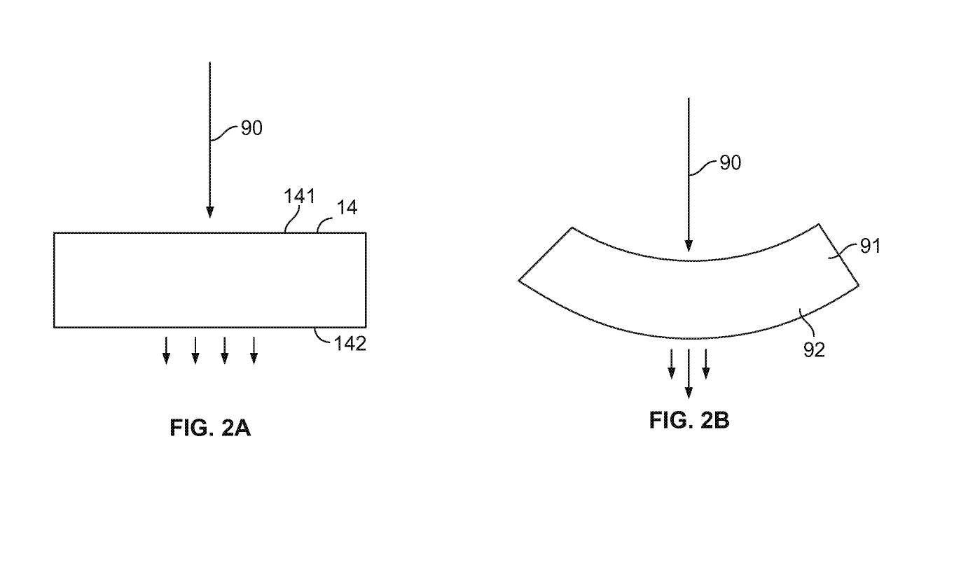

When pressure is applied on the substrate 14 from the inner surface 141, the pressure is transmitted through a relatively stiff substrate 14 (e.g., a silicon wafer) to press the outer surface 142 of the substrate against the polishing surface 181. As shown in FIGS. 2A and 2B, a stiff substrate 14 will “redistribute” a localized pressure 90 across a portion of the lower outer surface 142 below and around the application point of the localized pressure 90. In contrast, a layer 91 of a soft material performs less “redistribution” of the applied pressure, and transmits the pressure to a smaller localized region on an opposite surface 92.

In some implementations, to control the pressure applied to the substrate 14, adjacent concentric chamber zones 146a-146c in the carrier head are contiguously arranged without significant gaps or overlaps between the zones. As a result of the redistribution of pressure by the substrate 14, when different pressures are applied in adjacent regions from the inner surface side of the substrate, there is a gradual transition between the regions in the applied pressure on the outer surface side.

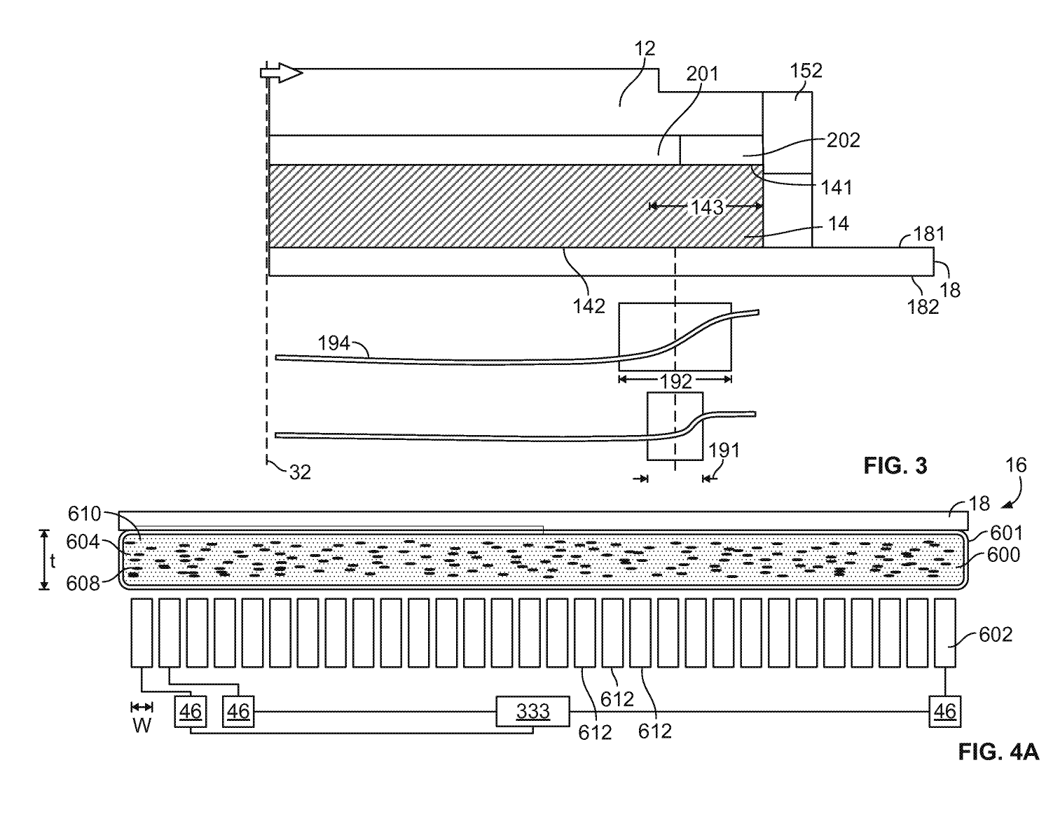

A nominal transition width 192 is obtained when different pressures are applied to adjacent regions of the inner surface 141 of the substrate 14 (see FIG. 3). A nominal interface pressure profile 194 may have a wider transition width than desired. It may be desirable to obtain a narrower transition width at the interface between two independently controllable regions. For example, it may be desirable to have narrower transition between an edge region 143 and a central region.

In some implementations, the edge region 143 may include the outermost 20 mm from the outer perimeter of the substrate. For a carrier head 12 having two concentric pressure chambers, a large central chamber 201 and a smaller rim chamber 202, the interface pressure profile experienced by the substrate will include a uniform (i.e. flat) portion in the center of the substrate and a transition region around the substrate edge (e.g., 20 mm from the outer perimeter of the substrate). Non-uniform interface pressure profile features tend to occur in a sub-region of the substrate edge (e.g., 10 mm from the edge), and due to the need for the pressure to be transmitted through the rigid substrate, fine interface pressure profile control of the zone transition at the substrate edge is difficult. The total width of the zone transition on both sides of the substrate when pressure is transmitted from the inner surface 141 to the outer surface 142 can be 20 to 30 mm.

Alternatively or in addition to applying or controlling the pressure on the substrate 14 from the inner surface 141, pressure can be applied directly to the outer surface 142 of the substrate 14. In particular, pressure is applied through the polishing pad 18 by pressing the polishing pad 18 against the substrate 14.

A potential advantage of this configuration is that it can achieve a narrower transition width. Narrower transition widths can be obtained when the interface pressure is applied directly at specific locations on the outer surface 142 without having to have the pressure be transmitted through the rigid substrate 14.

In some implementations, the pressure received by the outer surface 142 or different parts of the outer surface can be adjusted through the rigidity of the entire or part(s) of the platen 16. The force applied to the platen 16 to press the polishing pad against the surface 142 of the substrate 14 may remain the same or change within one polishing cycle in which the entire surface 142 is polished. For example, the force may remain constant, and the rigidity of the entire or part(s) of the platen 16 may be changed so that the pressure received by the surface 142 or different parts of the surface 142 is changed.

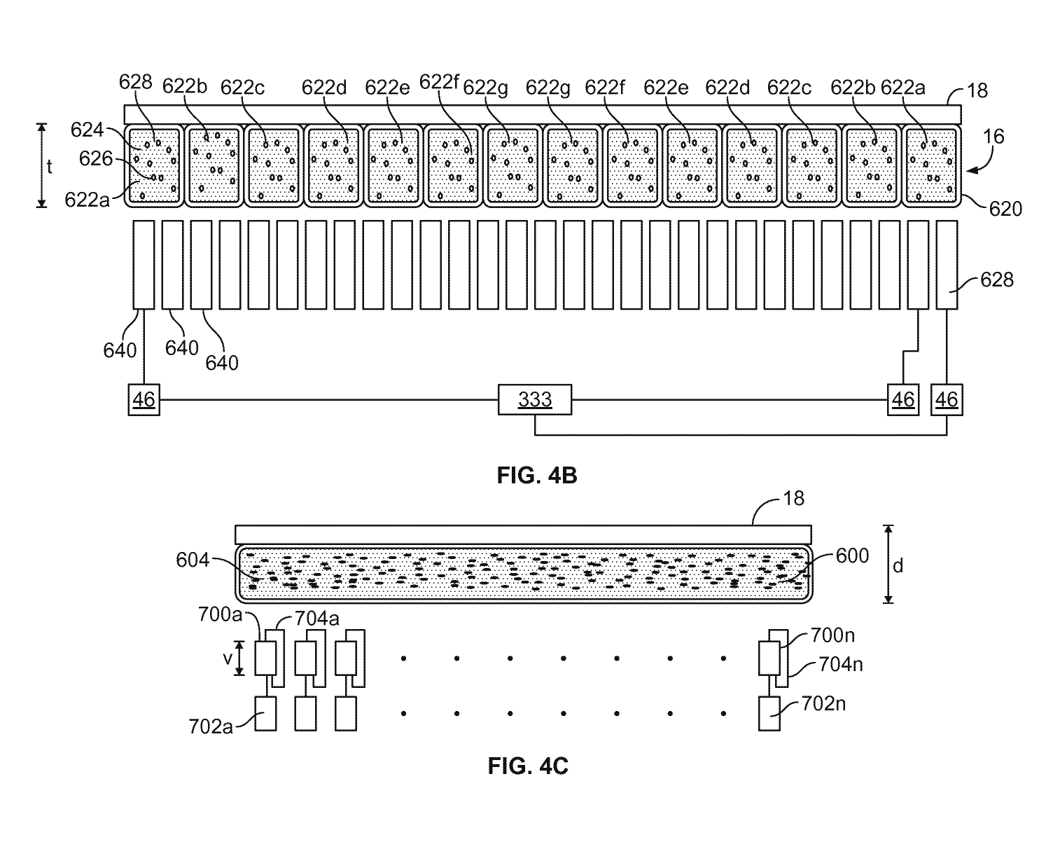

An example of the platen 16 that can have its rigidity adjusted is shown in FIG. 4A. The platen 16 is in the form of a bladder 600 that contains a fluid material 604. The bladder 600 has a wall 601 that changes its shape with the shape change of the fluid material. The rigidity of the platen 16 can be adjusted by adjusting the viscosity of the fluid material 604.

In some implementations, the viscosity of the fluid material 604 is responsive to an applied magnetic field. For example, the fluid material 604 can contain particles 608, such as iron particles or magnetic particles, dispersed, e.g., uniformly dispersed, in a carrier fluid 610, e.g., a carrier oil. Examples of suitable carrier oil may include hydrocarbon oils, mineral oils, or silicon oils. The dispersion and/or orientation of the magnetic particles 608 may change when the particles are subject to a magnetic field generated by an array 602 of magnets, such as electromagnets 612, and the change in the particle dispersion may change the viscosity of the fluid material 604.

In some implementations, as shown in FIG. 4C, permanent magnets 700a, . . . , 700n can be used. For example, strength of the magnetic field applied to the fluid material 604 is controlled by the distance d between the magnets and the platen 16. The magnets can be vertically movable along respective rails 704a, . . . , 704n in the direction V relative to the top of the platen by actuators.

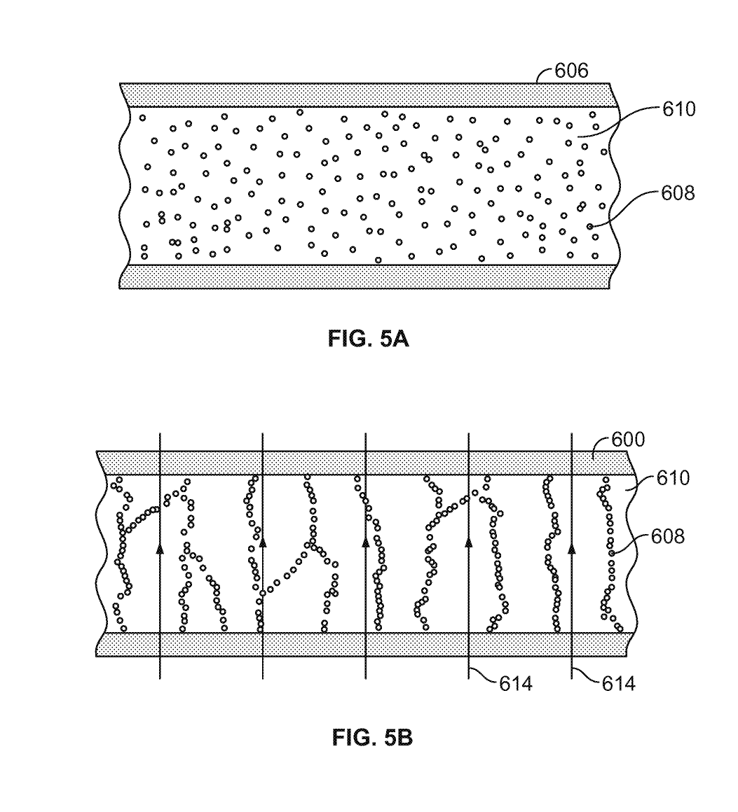

As an example, the dispersion of the magnetic particles in the carrier oil without a magnetic field is shown in FIG. 5A. When the particles are subject to a magnetic field having flux lines 614 shown in FIG. 5B, the particles align to form chains along the direction of the flux lines. For some fluid materials 604, the degree of particle alignment, i.e., how well the particles align within the carrier oil, can be affected by the magnitude (or intensity or strength) of the magnetic field, and different degrees of alignment may produce different degrees of platen rigidity. In some implementations, the rigidity of the platen can be continuously or non-continuously adjusted by changing the magnitude of the magnetic field. In some implementations, the aligned particles increase the viscosity of the fluid material 604 as compared to the randomly dispersed particles. Sometimes the viscosity increases sufficiently that a viscoelastic solid is formed.

In some implementations, the rigidity of the platen is changed at different locations such that when the force is applied to the platen, the shape of the platen changes at the different locations. The shape of the polishing pad changes with the platen. As a result, the pressure to be applied to the outer surface 142 is redistributed.

The bladder 600 can be made of an elastomeric, e.g., a rubber material. The surface area of the bladder 600 can be a typical size for a platen in chemical mechanical polishing. In some implementations, the bladder 600 has a relatively small thickness t (see, e.g., FIG. 4A), e.g., 500 millimeters or less, 400 millimeters or less, 300 millimeters or less, 200 millimeters or less, or 100 millimeters or less. Generally, magnetic force decreases quadratically with distance from the magnets. When the flux line of the magnetic field passes across the thickness of the bladder, the magnetic force does not significantly change when the bladder is thin. The thin bladder may allow a good control of the rigidity changes to the bladder across the thickness of the bladder.

The array 602 of electromagnets 612 can be an array in a grid of electromagnets 612. Alternatively, the electromagnets 612 can be a series of concentric annular electromagnets having different radii and arranged below the platen 16. Each electromagnet 612 can have a width w in the range of about 20 mm to about 50 mm. The widths of the electromagnets in the array 602 can be the same or can be different. Other sizes may also be used, for example based on the need for the shape change of the bladder 600. Sometimes the size of the electromagnet limits the coverage of the magnetic field and therefore, may affect the size of the shape change caused by the particular electromagnet. The electromagnets 612 may be evenly spaced in the array 602. However, other uneven spacing may also be used.

The electromagnets 612 or 630 can expand the entire surface area of the bladder 600 or 620, such that the rigidity or shape of the entire bladder or different parts of the bladder can be controlled through the electromagnets. In some implementations, the electromagnets can expand a subarea of the surface of the bladder, e.g., an array 650 of electromagnets 652 as shown in FIG. 1.

In some implementations, each electromagnet 612 can be independently controlled to change the shape of the polishing pad. Sometimes a number of the electromagnets 612 are grouped together and are controlled as a group independent of other groups of electromagnets.

In some implementations, instead of the bladder 600 having a single compartment as shown in FIG. 4A, the platen 16 can include multiple bladders or a single bladder having multiple compartments. Referring to FIG. 4B, the platen 16 includes a bladder 620 having multiple segmented compartments 622a-622g. The figure shows an example of arranging the compartments concentrically. Other arrangements, such as a grid, can also be used. Furthermore, instead of the single bladder 620, multiple bladders each corresponding to a compartment of the bladder 620 can be used.

Each of the multiple compartments 622a-622g can contain a fluid material 624 similar to or the same as the fluid material 604. In particular, the fluid material 624 has magnetic particles 626 dispersed in a carrier oil 628. The different compartments 622a-622g can contain the same fluid material or different fluid materials, e.g., based on the rigidity needs at different locations of the platen 16. In some implementations, the concentration of the magnetic particles within the fluid material can be different in different compartments. The segmented bladder can provide good control of fluid pooling. For example, when the magnetic particles 604 move to align, the particles may move the carrier fluid and pool the fluid to certain locations within the bladder 600 of FIG. 4A. Such fluid pooling changes the shape of the bladder in addition to the shape change resulting from the viscosity/rigidity changes. The bladder 620 having multiple compartments may limit the fluid pooling within each compartment and reduce the amount shape change caused by pooling the fluid at a scale larger than each compartment.

The rigidity or shape of the bladder 620 or the different compartments 622a-622g can be controlled using an array 628 of electromagnets 630. The electromagnets 620 can have features the same as or similar to those of the electromagnets 612.

In the example shown in FIGS. 1, 4A and 4B, each electromagnet is connected to electronic circuitry 406 that allows each electromagnet to be controlled individually to create magnetic fields of varying different magnitude as a function of time. In some implementations, the electromagnets are configured so that when an electrical current passes through the electromagnet, its polar axis is parallel to a direction along a thickness t of the bladder. Sometimes instead of an electromagnet, a permanent magnet may also be used. The electronic circuitry 406 is connected to a controller 333, which controls the current applied to the electromagnets for generating the magnetic field. The magnitude of the magnetic field can be controlled by controlling the current.

As the magnetic force decreases quadratically with distance, the magnetic force applied to the particles can also be adjusted by adjusting the distance between the electromagnets and the bladder. In the example shown in FIG. 1, the electromagnets are attached to a rail 35, which can move the electromagnets to adjust the magnetic force applied to the magnetic particles in the bladder. Fixing the electromagnets on a rail this way increases a distance between the surface 162 of the platen and the top surface of the electromagnet. Alternatively, different mounting mechanisms (not shown) can be provided such that when the electromagnets are mounted on the different mounting mechanisms, the magnetic force generated by the electromagnets is different. For example, when the magnetic field generated by the electromagnets is not strong enough, the concentric series of electromagnets can be mounted by a bracket and fixed to the stationary point in the driving shaft 124 of the platen 16.

The interface pressure (between the polishing pad 18 and the outer surface 142 of the substrate 14) at an area of interest may require dynamic changes, e.g., the interface pressure at the same location may be required to be higher or lower at different times. The controller 333, the circuitry 46, and the electromagnets can be configured to change the shape/rigidity of the platen in real time in response to the need of changing the interface pressure.

Referring again to FIG. 1, the polishing pad 18 can include a relatively soft backing layer 110 that defines the lower surface 182 of the polishing pad 18 (i.e., a relatively compressible layer, such as a Suba-IV layer (from Rodel, Phoenix Ariz.)). When the shape of the platen 16 changes at selected locations, the pressure from the platen 16 is effectively transferred to a region on the polishing surface 181 directly in the vicinity above the selected locations or the entire platen.

Other features related to controlling the interface pressure between the polishing pad and the substrate by controlling the pressure applied to the substrate from the side of the polishing pad are described in U.S. Ser. No. 61/801,163, the entire content of which is incorporated herein by reference. One or more of those other features can be used in combination with the features described in the present disclosure.

A number of embodiments of the invention have been described. Nevertheless, it will be understood that various modifications may be made without departing from the spirit and scope of the invention. Accordingly, other implementations are within the scope of the following claims.

1. A polishing apparatus, comprising:
a platen having a first surface to support a polishing pad and a second surface opposite to the first surface, the platen comprising a platen material having an adjustable rigidity;
a carrier head to hold a substrate against the polishing pad; and
a control assembly adjacent the second surface of the platen and opposite to the carrier head, the control assembly being configured to control the rigidity of the platen material.

2. The polishing apparatus of claim 1, wherein the rigidity of the platen material is responsive to an applied magnetic field and that the control assembly generates a controllable magnetic field to be applied to the platen material.

3. The polishing apparatus of claim 2, wherein the platen comprises a bladder having a wall and containing a fluid material inside the wall, the fluid material comprises particles dispersed in a carrier fluid, and the dispersion and/or orientation of the particles is responsive to the controllable magnetic field.

4. The polishing apparatus of claim 2, wherein the control assembly comprises an array of electromagnets configured to produce the controllable magnetic field.

5. The polishing apparatus of claim 4, comprising a controller configured to control each of the electromagnets individually.

6. The polishing apparatus of claim 3, wherein the controllable magnetic field is produced such that the particles align in chains to change the viscosity of the fluid material in the bladder.

7. The polishing apparatus of claim 6, comprising a controller configured to change a magnitude of the controllable magnetic field produced by the electromagnets to change an interface pressure between the polishing pad and the substrate.

8. The polishing apparatus of claim 3, wherein the bladder comprises segmented compartments, each compartment containing the fluid material.

9. The polishing apparatus of claim 2, wherein the control assembly comprises a magnet mounted to a linear rail and an actuator to move the magnet along the rail to change magnetic force applied to the platen material.

10. The polishing apparatus of claim 9, wherein the magnets comprise permanent magnets.

11. A method comprising:
holding a substrate against a polishing pad supported by a first surface of a platen, the platen comprising a platen material having an adjustable rigidity;
polishing a surface of the substrate by applying an interface pressure between the substrate and the polishing pad; and
adjusting the interface pressure by adjusting the rigidity of the platen material.

12. The method of claim 11, wherein the platen material comprises particles dispersed in a carrier fluid, and adjusting the rigidity of the platen material comprises applying a magnetic field to the particles to align the particles and change the viscosity of the platen material.

13. The method of claim 12, wherein applying a magnetic field comprises providing an electrical current to an electromagnet located in the vicinity of the platen.

14. The method of claim 13, comprising applying the electrical current to an array of electromagnets located in the vicinity of the platen.

15. The method of claim 14, comprising controlling each of the electromagnets independently.

16. The method of claim 14, comprising applying electrical current to selected electromagnets of the array to adjust the rigidity of a selected portion of the platen.

17. The method of claim 11, wherein the interface pressure is adjusted continuously during the polishing.

18. The method of claim 11, wherein the interface pressure is applied directly on a first surface of the substrate being polished without first passing through a second surface of the substrate opposite to the first surface.
